(19) United States
(12) Patent Application Publication
(10) Pub. No.: US 2024/0384096 A1
(43) Pub. Date: Nov. 21, 2024

(54) Hydrolysis-stable thermoplastic polyurethanes, production process and use thereof

(71) Applicant: LANXESS Deutschland GmbH, Cologne (DE)

(72) Inventors: Wilhelm Laufer, Ellerstadt (DE); Thomas Facklam, Leverkusen (DE)

(73) Assignee: Lanxess Deutschland GmbH, Cologne (DE)

(21) Appl. No.: 18/287,477

(22) PCT Filed: Apr. 11, 2022
(86) PCT No.: PCT/EP2022/059644

§ 371 Date: Oct. 19, 2023

(30) Foreign Application Priority Data
Apr. 20, 2021 (EP) 21169389.0

(51) Int. Cl. C08L 79/08; C08J 3/20; C08K 5/42

(52) U.S. Cl. CPC C08L 79/08; C08J 3/203; C08K 5/42; C08J 2375/04

(57) ABSTRACT

The present invention relates to compositions containing:
(a) at least one carbodiimide
(b) sulfonic esters and
(c) thermoplastic polyurethane
and to a process for the production thereof and to the use thereof.

The present invention relates to the technical field of thermoplastic polyurethane, the production thereof and the uses thereof.

Thermoplastic polyurethane elastomers, referred to hereinafter in abbreviated form as TPUs, have long been known. Their industrial significance is based on the combination of high-level mechanical properties with the advantages of cost-effective thermoplastic processing. The use of different chemical formation components makes it possible to achieve a wide range of variation in mechanical properties.

An overview of TPUs, their properties, production and applications is provided for example in Hans-Georg Wussow: “Thermoplastic Elastomers”, Ullmann's Encyclopedia of Industrial Chemistry, Electronic Release, 7th ed., chap. 2 “Thermoplastic Polyurethane Elastomers”, Wiley-VCH, Weinheim 2004.

TPUs can be produced continuously or batchwise by various processes. The best known processes, which are also used industrially, are what is known as the belt process, for example in accordance with GB 1 057 018 A, and the extruder process, for example in accordance with U.S. Pat. No. 3,642,964.

TPUs are typically formed from linear polyhydroxy compounds, aromatic diisocyanates and diols.

Their hardness is adjusted by way of the content of what is known as the hard phase, which essentially consists of diisocyanate-diol segments. Suitable selection of the molar ratios of the formation components allows TPUs with hardnesses of Shore A 85 to Shore D 74 to be produced without difficulty. Although TPUs with a Shore A hardness of less than 85 can theoretically be obtained in the same way, a disadvantage is that the products can be handled only with difficulty during production, since they are extremely difficult to solidify and set.

Plasticizers are added to the thermoplastic polyurethanes in many applications so as to improve the properties of the shaped bodies. Most of these plasticizers are ester-based, but, on the other hand, impair the hydrolysis resistance of the polymer.

EP 3099725 1 discloses that this negative effect can for the most part be offset by adding a carbodiimide to the ester-based plasticizers selected from the group consisting of citric esters, acetylcitric esters, phthalic esters, benzoic esters, adipic esters, hydrogenated phthalic esters and phosphoric esters.

US2020071486A1 and EP0381897A1 disclose compositions containing a polyester-based NCO prepolymer having urethane groups, a monomeric aromatic carbodiimide (Stabaxol I: bis(2,6-diisopropylphenyl)carbodiimide) and ethyl p-toluenesulfonate.

In general, carbodiimides have already proved to be effective hydrolysis stabilizers for thermoplastics, including for thermoplastic ester-based polyurethanes. However, the carbodiimides have the disadvantage of being very expensive and of breaking down or evolving toxic gases (emission of isocyanates) during processing at relatively high temperatures. There was thus a need for compositions having improved hydrolysis resistance which make it possible to reduce the amount of carbodiimides used while maintaining the hydrolysis resistance of the polymer.

It was thus an object of the present invention to provide thermoplastic polyurethane compositions that have improved hydrolysis resistance and/or make it possible to reduce the amount of carbodiimide used while keeping the same hydrolysis stability.

It has now surprisingly been found that this object is achieved by compositions comprising the following components:
(a) at least one carbodiimide selected from the group consisting of oligomeric aliphatic carbodiimides, polymeric aliphatic carbodiimides, oligomeric aromatic carbodiimides and polymeric aromatic carbodiimides,
(b) sulfonic esters of C₂-C₂₀-alkyl mono- or disulfonic acids with unsubstituted or C₁- to C₄-alkyl- and/or halogen-substituted phenol, and
(c) thermoplastic polyurethane.

Preference is given to using, as component (a), carbodiimides of formula (I)

R²-R¹-(—N═C═N-R¹-)ₙ-R² (i),
where
n corresponds to an integer from 2 to 500, preferably 2 to 100, further preferably 3 to 20, very particularly preferably 4 to 10,
R¹ represents C₁-C₂₄-alkylenes, C₅-C₁₂-cycloalkylenes, C₁-C₁₂-alkyl-substituted or C₁-C₂₄-oxyalkyl-substituted C₆-C₁₂-cycloalkylenes, C₇-C₂₄-arylalkylenes, C₁-C₁₂-alkyl-substituted C₆-C₁₀-arylenes, C₇-C₁₃-alkylaryl-substituted C₆-C₁₀-arylenes, and optionally C₁-C₁₂-alkyl-substituted C₁-C₁₀-arylenes that are bridged via alkylene groups and have a total of 8 to 30 carbon atoms, and/or C₆-C₁₀-arylenes,
R² is —H, —NCO, —NHCONHR³, —NHCONR³R⁴ or —NHCOOR⁵ and where
   R³ and R⁴ are identical or different and represent a C₁-C₁₂-alkyl, C₆-C₁₂-cycloalkyl, C₇-C₁₃-aralkyl or aryl radical, and
   R⁵ corresponds to a C₁-C₂₂-alkyl, C₆-C₁₂-cycloalkyl, C₆-C₁-aryl or C₇-C₁₃-aralkyl radical, and an unsaturated alkyl radical having 2-22 carbon atoms or an alkoxypolyoxyalkylene radical, preferably a methoxylated polyethylene glycol radical of the formula: —(CH₂CH₂O)ₘ—CH₃ with m=1 to 20.

Particularly preferably usable as component (a) are carbodiimides in which
R¹ represents C₁-C₁₂-alkyl-substituted C₆-C₁₀-arylenes, C₇-C₁₃-alkylaryl-substituted C₆-C₁₀-arylenes, and optionally C₁-C₁₂-alkyl-substituted C₆-C₁₀-arylenes that are bridged via alkylene groups and have a total of 8 to 30 carbon atoms, and/or C₆-C₁₀-arylenes and
R² represents H or —NHCOOR⁵.

Further preferred as component (a) are carbodiimides in which
R¹ represents C₁-C₆-alkyl-substituted C₆-C₁₀-arylenes and/or C₆-C₁₀-arylenes,
R² represents NHCOOR⁵ and R⁵ represents a methoxylated polyethylene glycol radical of the formula: —(CH₂CH₂O)ₘ—CH₃ with m=1 to 20.

The optionally C₁-C₁₂-alkyl-substituted C₆-C₁₀ arylenes that are bridged via alkylene groups and have a total of 8 to 30 carbon atoms have the general structure -alkylene-arylene-alkylene-, where the alkylene groups may be linear or branched and the arylene group may have up to four C₁-C₁₂-alkyl substituents, with the proviso that the total number of carbon atoms is not more than 30.

Preference is given here to C₆-C₁₂-arylenes that are bridged via alkylene groups and have no alkyl groups on the arylene group, and in which the two alkylene groups each have 1 to 6 carbon atoms.

Most preferred as component (a) are carbodiimides in which R¹ represents —C(CH₃)₂-C₆H₄—C(CH₃)₂— and R⁵ represents a methoxylated polyethylene glycol radical of the formula: —(CH₂CH₂O)ₘ—CH₃ with m=1 to 20.

Preferably used as component (b) are sulfonic esters of C₁₂-C₁₈-alkyl mono- or disulfonic acids with unsubstituted or C₁- to C₄-alkyl- and/or halogen-substituted phenol.

Particularly preferably used as component (b) are sulfonic esters of C₁₂-C₁₈-alkyl mono- or disulfonic acids with unsubstituted or C₁- to C₄-alkyl- or halogen-substituted phenol.

Most preferably used as component (b) are sulfonic esters of C₁₄-C₁₇-alkyl mono- or disulfonic acids with phenol.

The weight ratio of component (a) to component (b) in the compositions according to the invention is preferably from 30:70 to 70:30, particularly preferably from 40:60 to 60:40 and most preferably 50:50.

The weight ratio of component (a) to thermoplastic polyurethane in the compositions according to the invention is preferably from 2:1000 to 25:1000, particularly preferably from 5:1000 to 10:1000 and most preferably 7:1000 to 8:1000.

Preferably, the NCN content (carbodiimide group content) in the compositions according to the invention is 1-10% by weight, preferably 2-8% by weight, particularly preferably 3-7% by weight, based on the total amount of carbodiimide and alkylsulfonic ester.

The present invention further provides a process for the production of a thermoplastic polyurethane composition, wherein component (a) and component (b) are added to a reaction mixture for the production of thermoplastic polyurethane, and the thermoplastic polyurethane is subsequently formed by polymerization of the reaction mixture.

In a preferred embodiment, component (a) and component (b) are firstly mixed and then the mixture is added to the reaction mixture for the production of thermoplastic polyurethane.

In a preferred embodiment, used as component (a) are carbodiimides of formula (I) which do not have an NCO function as R² radical.

If the composition is added to a reaction mixture, this can in principle be performed at any stage in the production process of a thermoplastic polyurethane.

In an alternative embodiment, component (a) and component (b) are blended with a thermoplastic polyurethane.

If the mixture of components (a) and (b) is added to a thermoplastic polyurethane that has already essentially undergone full reaction, this can for example be performed by means of incorporation by compounding or incorporation by swelling.

The invention further provides shaped bodies, in particular in the form of rollers, conveyor belts or membranes, which comprise the composition according to the invention.

The scope of the invention encompasses all definitions of radicals, indices, parameters and elucidations given above or hereinafter, in general terms or in preferred ranges, together with one another, i.e. including any combinations between the respective ranges and preferred ranges.

The examples that follow serve to elucidate the invention, without having any limiting effect.

### WORKING EXAMPLES

Carbodiimide (CDI): Polycarbodiimide of formula (I) with R¹=m-tetramethylxylene, R²=NHCOOR⁵, R⁵=—(C₂H₅₀)ₘ—CH₃, with n=about 4-5, m=about 11 and an NCN content of about 7% by weight. To determine the NCN content, the NCN groups were reacted with oxalic acid added in excess, and the unreacted oxalic acid was then potentiometrically back-titrated with sodium methoxide, taking into account the blank value of the system.

### Monomeric Carbodiimide (CDI*):

Monomeric carbodiimide bis(2,6-diisopropylphenyl)carbodiimide and an NCN content of approx. 11% by weight. To determine the NCN content, the NCN groups were reacted with oxalic acid added in excess, and the unreacted oxalic acid was then potentiometrically back-titrated with sodium methoxide, taking into account the blank value of the system.

Ester (1): Alkylsulfonic ester containing secondary C₁₄-C₁₇-alkyl mono- or disulfonic esters with phenol (Mesamoll® from Lanxess Deutschland GmbH)

Ester (II): Tri-n-butyl citrate (Uniplex 83 from Lanxess Deutschland GmbH)

Thermoplastic polyurethane (TPU): Desmopan® 2587 A from Covestro AG

### Hydrolysis Stabilization in Thermoplastic Polyurethane (TPU)

To evaluate the hydrolysis-stabilizing action in TPU, the polycarbodiimide or the compositions composed of ester and polycarbodiimide (with a weight ratio of ester to polycarbodiimide of 1:1) were dispersed into TPU by means of a ZSK 25 laboratory twin-screw extruder from Werner & Pfleiderer prior to the measurement described below. F3 standard test specimens used for measuring tear strength were then produced from the resultant pellets on an Arburg Allrounder 320 S 150-500 injection moulding machine.

For the hydrolysis test, these F3 standard test specimens were stored in water at a temperature of 90° C. and the tear strength thereof was measured in MPa. The results are shown in Table 1:

TABLE 1
Hydrolysis test

| | | | | Ex. 4 |
|---|---|---|---|---|
| | Ex. 1 | Ex. 2 | Ex. 3 (Inv.) | (Comparative) |
| | (Comparative) | (Comparative) | 0.75% by weight | 0.75% by |
| | 0.75% by | 1.0% by | each of | weight each of |
| | weight of CDI | weight of CDI | ester (I) + CDI | ester (II) + CDI |
| Period of stability | 49 days | 54 days | 55 days | 49 days |
| with relative tear | | | | |
| strength exceeding | | | | |
| 50% of the initial | | | | |
| value | | | | |

The results in Table 1 show that the composition according to the invention enables a reduction in the proportion of carbodiimide in the TPU by min. 25%. The esters known from the prior art do not show any improvement here.

TABLE 2
Hydrolysis test

| | | Ex. 6 (Comparative) |
|---|---|---|
| | Ex. 5 (Comparative) | 0.75% by weight each of |
| | 1.0% by weight of CDI* | ester (I) + CDI* |
| Period of stability | 23 days | 19 days |
| with relative tear | | |
| strength exceeding | | |
| 50% of the initial | | |
| value | | |

The results in Table 2 show that monomeric carbodiimides in combination with ester (I) do not enable a reduction in the proportion of carbodiimide in the TPU.

1. A composition comprising:
(a) at least one carbodiimide selected from the group consisting of oligomeric aliphatic carbodiimides, polymeric aliphatic carbodiimides, oligomeric aromatic carbodiimides and polymeric aromatic carbodiimides,
(b) sulfonic esters of C₂-C₂₀-alkyl mono- or disulfonic acids with unsubstituted or C₁- to C₄-alkyl- and/or halogen-substituted phenol, and
c) thermoplastic polyurethane.

2. The composition according to claim 1, wherein the carbodiimide is selected from carbodiimides of formula (I)
R²-R-(—N═C═N-R-)ₙ-R² (I),
where
n corresponds to an integer from 2 to 500,
R¹ represents C₁-C₂₄-alkylenes, C₅-C₁₂-cycloalkylenes, C₁-C₁₂-alkyl-substituted or C₁-C₂₄-oxyalkyl-substituted C₆-C₁₂-cycloalkylenes, C₇-C₂₄-arylalkylenes, C₁-C₁₂-alkyl-substituted C₆-C₁₀-arylenes, C₇-C₁₃-alkylaryl-substituted C₆-C₁₀-arylenes, and optionally C₁-C₁₂-alkyl-substituted C₆-C₁₀-arylenes that are bridged via alkylene groups and have a total of 8 to 30 carbon atoms, and/or C₆-C₁₀-arylenes,
R² is —H, —NCO, —NHCONHR³, —NHCONR³R⁴ or —NHCOOR⁵,
where
R³ and R⁴ are identical or different and represent a C₁-C₁₂-alkyl, C₆-C₁₂-cycloalkyl, C₇-C₁₃-aralkyl or aryl radical, and
R⁵ corresponds to a C₁-C₂₂-alkyl, C₆-C₁₂-cycloalkyl, C₆-C₁₃-aryl or C₇-C₁₃-aralkyl radical, and an unsaturated alkyl radical having 2-22 carbon atoms or an alkoxypolyoxyalkylene radical.

3. The composition according to claim 1, wherein the weight ratio of component (a) to component (b) is from 30:70 to 70:30.

4. The composition according to claim 1, wherein the weight ratio of component (a) to thermoplastic polyurethane is from 2:1000 to 25:1000.

5. The composition according to claim 1, wherein used as component (b) are sulfonic esters of C₁₂-C₁₃-alkyl mono- or disulfonic acids with unsubstituted or C₁- to C₄-alkyl- and/or halogen-substituted phenol.

6. The composition according to claim 2, wherein
R¹ represents C₁-C₁₂-alkyl-substituted C₆-C₁₀-arylenes, C₇-C₁₃-alkylaryl-substituted C₆-C₁₀-arylenes, and optionally C₁-C₁₂-alkyl-substituted C₆-C₁₀-arylenes that are bridged via alkylene groups and have a total of 8 to 30 carbon atoms, and/or C₆-C₁₀-arylenes and
R² represents H or —NHCOOR₅.

7. The composition according to claim 2, wherein
R¹ represents C₁-C₆-alkyl-substituted C₆-C₁₀-arylenes and/or C₆-C₁₀-arylenes,
R² represents NHCOOR₅, and
R⁵ represents a methoxylated polyethylene glycol radical of the formula: —(CH₂CH₂O)ₘ—CH₃ with m=1 to 20.

8. The composition according to claim 2, wherein R¹ represents —C(CH₃)₂-C₆H₄—C(CH₃)₂— and R⁵ represents a methoxylated polyethylene glycol radical of the formula: —(CH₂CH₂O)ₘ—CH₃ with m=1 to 20.

9. A process for the production of a composition according to claim 1, wherein component (a) and component (b) are added to a reaction mixture for the production of the thermoplastic polyurethane, and the thermoplastic polyurethane is subsequently formed by polymerization of the reaction mixture.

10. The process according to claim 9, wherein component (a) and component (b) are firstly mixed and then the mixture is added to the reaction mixture for the production of the thermoplastic polyurethane.

11. A process for the production of a composition according to claim 1, wherein component (a) and component (b) are blended with the thermoplastic polyurethane.

12. The process according to claim 11, wherein the blending is performed by means of incorporation by compounding or incorporation by swelling.

13. A shaped body comprising a composition according to claim 1.

14. The shaped body according to claim 13, in the form of rollers, conveyor belts or membranes.
